(19) United States
(12) Patent Application Publication
(10) Pub. No.: US 2010/0008366 A1
(43) Pub. Date: Jan. 14, 2010

(54) MESSAGE TRANSFER PROGRAM, MESSAGE TRANSFER METHOD, AND MESSAGE TRANSFER SYSTEM

(75) Inventors: Toshiya Hanamori, Kawasaki (JP); Masaaki Mori, Kawasaki (JP); Daisuke Shimabayashi, Kawasaki (JP); Yasumasa Oshiro, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/562,835

(22) Filed: Sep. 18, 2009

Related U.S. Application Data
(63) Continuation of application No. PCT/JP2007/056697, filed on Mar. 28, 2007.

(51) Int. Cl. H04L 12/56

(52) U.S. Cl. 370/392

(57) ABSTRACT

A transmitting apparatus extracts header information from messages stored in a queue to generate a digest by collecting the extracted header information. The transmitting apparatus transmits the digest to receiving apparatuses specified by address information stored in a address information storage unit. Upon receiving a message obtaining request specifying any header information contained in the digest from any of receiving apparatuses, the transmitting apparatus reads out a message corresponding to the specified header information from the queue to transmit the message to the receiving apparatus that transmitted the message obtaining request. The receiving apparatus stores therein receiving conditions that specifies a message to be received from the transmitting apparatus and searches the digest received from the transmitting apparatus for the header information that satisfies the receiving conditions. The receiving apparatus transmits a message obtaining request that contains the retrieved header information that satisfies the receiving conditions to the transmitting apparatus.

### CROSS-REFERENCE TO RELATED APPLICATION(S)

This application is a continuation of PCT international application Ser. No. PCT/JP2007/056697 filed on Mar. 28, 2007 which designates the United States, incorporated herein by reference, the entire contents of which are incorporated herein by reference.

### FIELD

The embodiments discussed herein are directed to a message transfer program, a message transfer method, and a message transfer system.

### BACKGROUND

Conventionally, a technology has been devised that enables applications to cooperate to process business operations among a plurality of systems including information processing devices that are different in located areas, business applications, operating systems (OSs), and the like, while the information processing devices ensuring independency of each system. Generally, such technology uses asynchronous communication using queues.

In particular, as depicted in FIG. 10, information processing devices 10 to 30 each include queues and an inter-queue transfer controlling unit. Each of the information processing devices 10 to 30 stores messages generated by applications or messages received from other information processing devices in the queue. Receiving and transmitting messages from/to other information processing devices are controlled by the inter-queue transfer controlling unit. In this way, each of the information processing devices 10 to 30 enables the applications to cooperate to process business operations among the information processing devices in other systems, while ensuring independency of each system. FIG. 10 is a schematic for explaining the conventional asynchronous communication system using queues.

To connect these systems including such information processing devices to enable the applications to cooperate to process business operations, it is required to set a predetermined communication definition and to specify correspondence among the information processing devices. Methods that set three typical communication definitions are explained below. In FIG. 10, it is assumed that the information processing device 10 is a transmitting terminal, an information processing device 20 is a receiving terminal, and a system including both of the information processing devices 10 and 20 is newly connected.

An example in which the transmitting terminal initiatively sets the communication definition is explained. In particular, as depicted in FIG. 11, an inter-queue transfer controlling unit 11 in the information processing device 10 stores therein a destination of a message (address information of the information processing device) and a location to store the message (reception queue identifying information) in association with each other for each queue (transmission queue identifying information) (see table 11a). For example, to newly set the communication definition with respect to the information processing device 20, the inter-queue transfer controlling unit 11 stores the destination of the message “111.222.333.444” and the stored location of the message “q1” in association with each other in the queue “Q1” (Associating these pieces of information is performed by an operator).

When the application stores the message in the queue (the application selects the queue to store the information therein depending on the destination of the message), at a predetermined timing, the inter-queue transfer controlling unit 11 transmits the message such that the message is to be stored in the reception queue associated with the queue in the information processing device associated with the queue. Upon receiving the message, the inter-queue transfer controlling unit in the destination information processing device stores the message in the specified queue. For example, the inter-queue transfer controlling unit 11 adds reception queue identifying information “q1” to a header of a message 13 stored in a queue 12 and then transmits the message 13 to the information processing device 20 (see table 11a). Upon receiving the message 13, an inter-queue transfer controlling unit 21 in the information processing device 20 stores the message in a queue 22 based on the reception queue identifying information “q1” added to the header. FIG. 11 is a schematic for explaining how the conventional transmitting terminal initiatively sets the communication definition.

Another method that sets the communication definition with the transmitting terminal taking initiative. In particular, as depicted in FIG. 12, the inter-queue transfer controlling unit 11 in the information processing device 10 stores therein a location to store the message (reception queue identifying information) and the information processing device (the address information of the information processing device) including the reception queue in association with each other (see table 11b). In this case, the information processing device 10 is sufficient to include only one queue. For example, to newly set the communication definition with respect to the information processing device 20, the inter-queue transfer controlling unit 11 stored therein the reception queue 22 “q1” and the address “111.222.333.444” of the information processing device 20 that includes the reception queue 22 “q1” in association with each other (Associating these pieces of information is also performed by an operator).

When the application stores the message in the queue (the application specifies the location to store the information (reception queue identifying information)), at a predetermined timing, the inter-queue transfer controlling unit 11 transmits the message such that the message is to be stored in the reception queue at the location in the information processing device corresponding to the location to store the message. Upon receiving the message, the inter-queue transfer controlling unit in the destination information processing device stores the message in the specified queue. For example, the inter-queue transfer controlling unit 11 reads out the message 13 from the queue 12, the message 13 having the reception queue identifying information “q1” added to its header and then transmits the message 13 to the information processing device 20 having the address of “111.222.333.444” associated with the reception queue identifying information “q1” (see table 11b). Upon receiving the message 13, the inter-queue transfer controlling unit 21 in the information processing device 20 stores the message 13 in the queue 22 based on the reception queue identifying information “q1” added to the header. FIG. 12 is a schematic for explaining how the conventional transmitting terminal initiatively sets the communication definition.

An example in which the receiving terminal initiatively sets the communication definition is explained. In particular, as depicted in FIG. 13, the inter-queue transfer controlling unit 21 in the information processing device 20 stores therein an source of a message (address information of the information processing device) and a stored location of the message (the transmission queue identifying information) in association with each other for each queue (each pieces of the reception queue identifying information) (see table 21a). For example, to newly set the communication definition with respect to the information processing device 10, the inter-queue transfer controlling unit 21 stores the source of the message “111.222.333.111” and the stored location of the message “Q1” in association with each other in the reception queue “q1” (Associating these pieces of information is performed by an operator).

Then, at a predetermined timing, the inter-queue transfer controlling unit 21 makes reference to the association to request each information processing device to transmit the message. The information processing devices that are requested to transmit the message transmit the message as requested. For example, the inter-queue transfer controlling unit 21 requests the information processing device 10 to store the message stored in the transmission queue “Q1” in the reception queue “q1”. The inter-queue transfer controlling unit 11 in the information processing device 10 adds the reception queue identifying information “q1” to the header of the message 13 stored in the queue 12 and then transmits the message 13 to the information processing device 20. Upon receiving the message 13, the inter-queue transfer controlling unit 21 in the information processing device 20 stores the message 13 in the queue 22 based on the reception queue identifying information “q1” that is added to the header. FIG. 13 is a schematic for explaining how the conventional receiving terminal initiatively sets the communication definition.

As a technology that controls communication with the transmitting terminal having initiative, related technology is disclosed in Japanese Laid-open Patent Publication No. 2002-335283. A transmitting terminal transmits broadcast communication data with a parameter specifying a receiving terminal added to the head of the broadcast communication data, and the receiving terminal analyzes the added parameter to determine whether to receive or to discard the broadcast communication data.

As a technology that controls communication with the receiving terminal having initiative, related technology is disclosed in, Japanese Laid-open Patent Publication No. 2005-86362 that enables a client (receiving) terminal that receives and performs streaming play back of an MP4 file such as a live content to request the source (transmitting) server that distributes the MP4 file to transmit a response including an initial header and latest fragment of the MP4 file using hypertext transfer protocol (HTTP) instead of conventionally used communication protocol such as real-time transport protocol (RTP) or user datagram protocol (UDP), enabling to perform streaming play back of the MP4 file in real time.

However, the conventional technology has a problem of not being able to flexibly construct communication relationships among the systems.

In particular, when the transmitting terminal initiatively sets the communication definition, following problems arise. (1) Each time a receiving system is added or modified, a transmitting system needs to modify the definition, resulting in troublesome tasks of constructing communication relationships. (2) The transmission queues are needed as much as that of the receiving systems or the reception queues in the receiving systems. Therefore, each time the receiving system is added or modified, the transmission queue needs to be added, resulting in troublesome tasks of constructing communication relationships. (3) The application needs to modify a logic used to store the message in synchronous with the addition or modification of the receiving system, resulting in troublesome tasks of constructing communication relationships. (4) With the addition of the receiving system, the number of the definitions managed by the transmitting system increases and more memory capacity will be needed. Therefore, it is impossible to construct communication relationships at low cost. (5) Each time the reception queue is added, because the transmitting system is required to match the reception queues with the destination systems, central processing unit (CPU) load per message is increased, resulting in lowered processing rate. (6) Each time the receiving conditions of the receiving system are modified, the transmitting system needs to reset the distribution conditions, resulting in troublesome tasks of constructing communication relationships.

Further, when the receiving terminal initiatively sets the communication definition, following problems arise. (7) The transmission queues are needed as much as that of the receiving systems or the queues in the receiving systems. Therefore, each time the receiving system is added or modified, the transmission queue needs to be added, resulting in troublesome tasks of constructing communication relationships. (8) The application needs to modify a logic used to store the message in synchronous with the addition or modification of the receiving system, resulting in troublesome tasks of constructing communication relationships. (9) The receiving system needs to continuously monitor the transmission queues included in the transmitting system such as by polling the transmission queues whether the message is stored therein. Therefore, when the number of transmitting system increases, the processing load also increases.

### SUMMARY

According to an aspect of the invention, a computer readable storage medium contains instructions that, when executed by a computer functioning as a transmitting apparatus that transfers a message stored in a queue to a plurality of receiving apparatuses communicatively connected to each other via a network, causes the computer to perform extracting header information that uniquely specifies each message from a plurality of such messages stored in the queue to generate a digest by collecting the extracted header information; transmitting the digest generated at the extracting to the receiving apparatuses; and reading out, upon receiving a message obtaining request specifying any header information contained in the digest from any of the receiving apparatuses, a message corresponding to the specified header information from the queue to transmit the message to the receiving apparatus that transmitted the message obtaining request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic for explaining an overview and features of a message transfer system according to a first embodiment of the present invention;

FIG. 2 is a block diagram of a transmitting apparatus in the message transfer system according to the first embodiment;

FIG. 3 is exemplary information stored in a destination management list storage unit;

FIG. 4 is a block diagram of a receiving apparatus in the message transfer system according to the first embodiment;

FIG. 5 is exemplary information stored in a receiving condition storage unit;

FIG. 6 is a flowchart of a process flow of generating a destination management list according to the first embodiment;

FIG. 7 is a flowchart of a process flow of obtaining a message according to the first embodiment;

FIG. 8 is a flowchart of a process flow of receiving a message according to the first embodiment;

FIG. 9 is a schematic of a computer that executes a message transfer program;

FIG. 10 is a schematic for explaining a conventional asynchronous communication system using a queue;

FIG. 11 is a schematic for explaining how a conventional transmitting terminal initiatively sets a communication definition;

FIG. 12 is a schematic for explaining how the conventional transmitting terminal initiatively sets the communication definition; and

FIG. 13 is a schematic for explaining how a conventional receiving terminal initiatively sets the communication definition.

### DESCRIPTION OF EMBODIMENTS

Preferred embodiments of a message transfer system according to the present invention are described in detail below with reference to the accompanying drawings. The explanation of terms, an overview and features of the message transfer system according to the present invention, structures and process flows of a transmitting apparatus and a receiving apparatus are explained in this order below. After explaining effects of the first embodiment, other embodiments will be explained.

### [a] First Embodiment

<Explanation of Terms>

The major terms used in the embodiment described below are explained. A term “message” (corresponding to a term “message” set forth in claims) refers to data unit that is cooperatively processed among the applications in a plurality of information processing devices. The message includes a header and a message content.

A term “header” (corresponding to a term “header information” set forth in claims) refers to information that uniquely specifies the message and includes, in particular, information indicating reception queue identifying information, a destination, a product name, or the like. While, in the embodiments described below, the header is explained as including only information indicating the product name, the present invention is not limited to this. The header may include other information (e.g., the reception queue identifying information and the destination) or different pieces of information (e.g., the reception queue identifying information and the destination).

A term “digest” (corresponding to a term “digest” set forth in claims) refers to data that is formed by packing (combining) the headers of the messages. While, in the embodiments described below, the digest is explained as formed by packing a fixed number of the headers, the present invention is not limited to this. For example, the number of headers packed to form the digest may be dynamically modified depending on network line conditions or accumulation conditions of the message.

<Overview and Features of Message Transfer System>

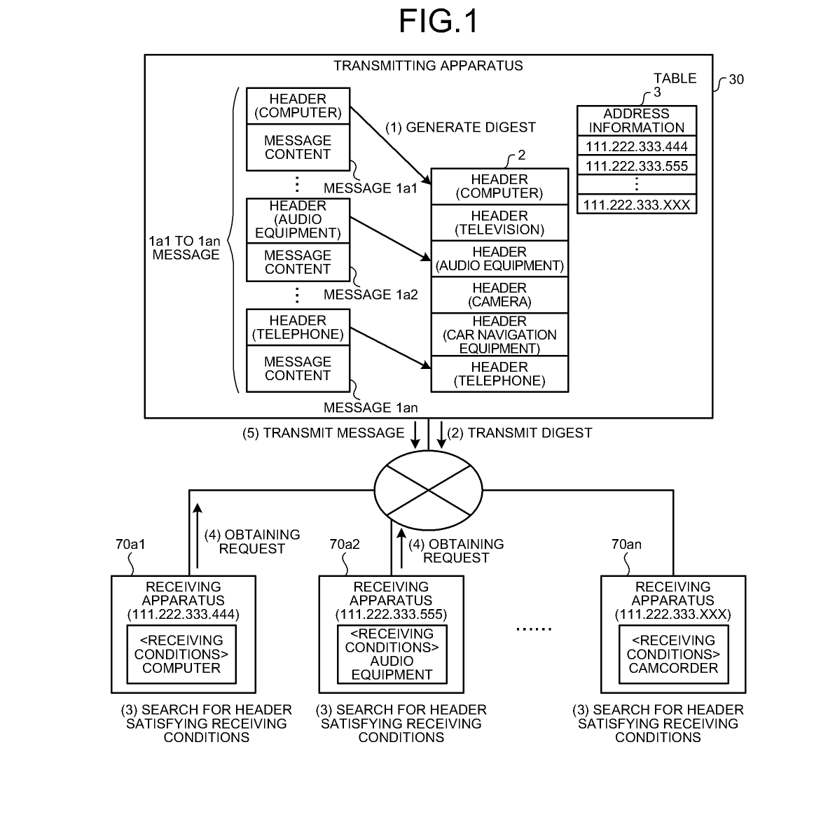

Referring to FIG. 1, a message transfer system according to a first embodiment is explained. FIG. 1 is a schematic for explaining an overview and features of a message transfer system according to the first embodiment. As depicted in FIG. 1, the message transfer system includes a transmitting apparatus 30 that transmits messages and a plurality of receiving apparatuses 70a1 to 70an that receive the messages, all of which are communicatively connected via a network.

As an overview, the message transfer system according to the first embodiment includes: the transmitting apparatus that stores the message resulted from an application processing in a queue and reads out the message from the queue to transmit the message to the receiving apparatus that will cooperatively process the message; and the receiving apparatuses that receive the message from the transmitting apparatus and store the message in a queue to continue to cooperatively process the messages of the applications. The cooperative processing with respect to the messages are performed asynchronously. As a main feature, it is possible to flexibly construct the communication relationship among systems including the apparatuses.

To explained the main feature, in the message transfer system, the transmitting apparatus 30 stores therein address information of the receiving apparatuses that is expecting to receive digests. In particular, as depicted in FIG. 1, the transmitting apparatus 30 stores therein the address information of the receiving apparatuses 70a1 to 70an (see table 3).

The transmitting apparatus 30 extracts the header that uniquely specifies each of the messages stored in the queue to generate the digest having the extracted headers. In particular, as depicted in FIG. 1, the transmitting apparatus 30 extracts each header from messages 1a1 to 1an stored in its own queue to generate a digest 2 having the extracted headers (see in FIG. 1 (1)).

The transmitting apparatus 30 transmits the digest to the receiving apparatus specified by the address information stored therein. In particular, as depicted in FIG. 1, the transmitting apparatus 30 transmits the generated digest 2 to the receiving apparatuses 70a1 to 70an specified by the address information stored in table 3 (see in FIG. 1 (2)).

In the message transfer system, the receiving apparatus stores receiving conditions that is information used to specify the message to be received from the transmitting apparatus 30. For example, as depicted in FIG. 1, the receiving apparatus 70a1 stores therein a product name “computer”, which is a piece of information included in the header.

The receiving apparatus searches the digest received from the transmitting apparatus 30 for a header satisfying the receiving conditions stored therein. For example, as depicted in FIG. 1, upon receiving the digest 2 from the transmitting apparatus 30, the receiving apparatus 70a1 searches the headers included in the digest 2 for a header including the production name “computer” (see in FIG. 1 (3)). Similarly, the receiving apparatus 70a2 and the receiving apparatus 70an search the received digest 2 for a header satisfying the receiving conditions.

The receiving apparatus transmits a message obtaining request including the found header that satisfies the receiving conditions to the transmitting apparatus 30. For example, as depicted in FIG. 1, the receiving apparatus 70a1 searches the digest 2 for the header including the product name “computer”. As a result, if the header that satisfies the receiving conditions is found, the receiving apparatus 70a1 returns the header including the product name “computer” to the transmitting apparatus 30 to request the transmitting apparatus 30 to transmit the message to its own address “111.222.333.444” (see in FIG. 1 (4)).

Upon receiving a message obtaining request specifying any of the headers contained in the digest from any of the receiving apparatuses, the transmitting apparatus 30 reads out a message corresponding to the specified header to transmit the message to the receiving apparatus that transmitted the message obtaining request. In particular, the transmitting apparatus 30 receives a header containing the information indicating the product name “computer” from the receiving apparatus 70a1 and a header containing the information indicating the product name “audio equipment” from the receiving apparatus 70a2. Then, the transmitting apparatus 30 transmits the message 1a1 containing the information indicating the product name “computer” in its header out of the messages 1a1 to 1an stored in the queue to the receiving apparatus 70a1. The transmitting apparatus 30 also transmits the message 1a2 containing the information indicating the product name “audio equipment” in its header to the receiving apparatus 70a2 (see in FIG. 1 (5)).

By doing so, the message transfer system according to the first embodiment can flexibly construct the communication relationships among the systems as stated as the main feature.

<Structure of Transmitting Apparatus>

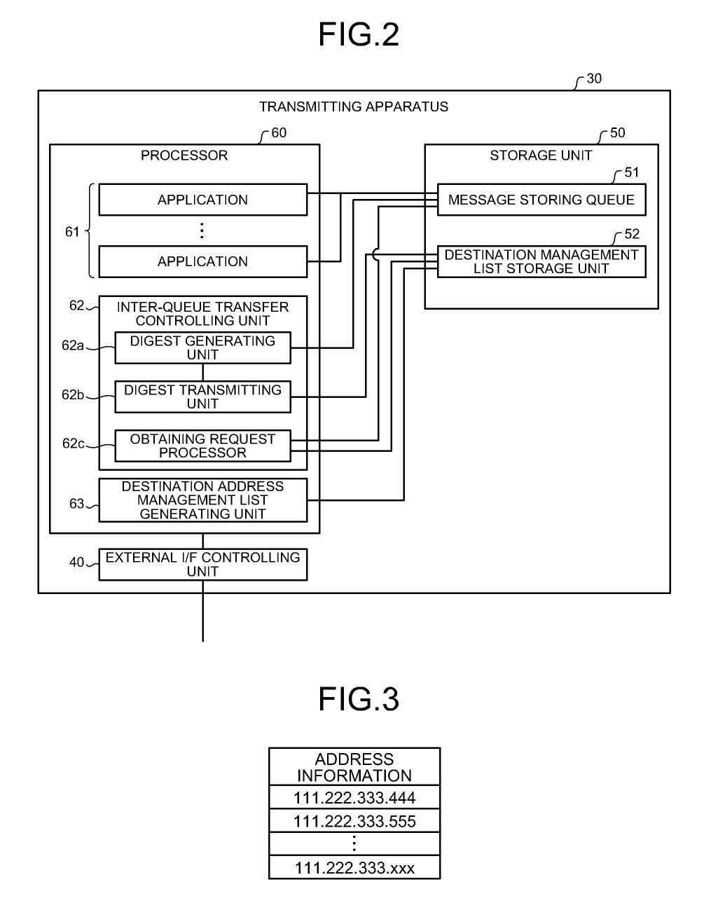

Referring to FIG. 2, components of the transmitting apparatus 30 in the message transfer system described in FIG. 1 are explained. FIG. 2 is a block diagram of the transmitting apparatus 30 according to the first embodiment. As depicted in FIG. 2, the transmitting apparatus 30 includes an external interface (I/F) controlling unit 40, a storage unit 50, and a processor 60.

The external I/F controlling unit 40 controls communication with the receiving apparatuses. In particular, the external I/F controlling unit 40 receives a digest output from a digest transmitting unit 62b described below to output the digest to a channel connected to the receiving apparatus or receives a message obtaining request transmitted from the receiving apparatus to pass the request to an obtaining request processor 62c described below.

The storage unit 50 stores therein data used for various processes performed by the processor 60 and the like. As components closely related to the present invention, the storage unit 50 includes a message storing queue 51 and a destination management list storage unit 52. The destination management list storage unit 52 corresponds to a phrase “address information storage unit” set forth in claims.

The message storing queue 51 stores therein messages until the messages are transmitted. In particular, the message storing queue 51 stores the messages therein until the messages are read out by the obtaining request processor 62c described below.

The destination management list storage unit 52 stores therein the address information of the receiving apparatuses that is expecting to receive a digest. In particular, upon receiving the address information from a destination address management list generating unit 63 described below, the destination management list storage unit 52 stores the address information therein. For example, as depicted in FIG. 3, the destination management list storage unit 52 stores therein the address information “111.222.333.444” or the like. FIG. 3 is exemplary information stored in the destination management list storage unit.

The processor 60 is a processing unit that includes an internal memory that stores therein computer programs and controlling data that specify various process procedures and executes various processes using the computer programs and controlling data. As components closely related to the present invention, the processor 60 includes applications 61, an inter-queue transfer controlling unit 62, and the destination address management list generating unit 63. The inter-queue transfer controlling unit 62 includes a digest generating unit 62a, the digest transmitting unit 62b, and the obtaining request processor 62c. The digest generating unit 62a corresponds to a phrase “digest generating unit” set forth in claims. Similarly, the digest transmitting unit 62b corresponds to a phrase “digest transmitting unit” set forth in claims. Similarly, the obtaining request processor 62c corresponds to a phrase “message transmitting unit” set forth in claims.

The applications 61 generate messages subjected to cooperative processing among the applications in the receiving apparatuses. In particular, upon receiving an input from a user via an input unit (not depicted), the application 61 performs particular processing to the input to store a resultant message in the message storing queue 51. For example, when a process of receiving an order for a computer to a process of delivering the computer through a process of producing are cooperatively processed, one of the applications 61 in charge of ordering process receives a number of ordered products, a deadline, or the like from a user, performs a particular process to generate a message (which has a header containing the information indicating the product name “computer”), and stores the message in the message storing queue 51.

The inter-queue transfer controlling unit 62 is a processing unit that controls cooperative processing with an application 102 in a receiving apparatus 70. The inter-queue transfer controlling unit 62 includes the digest generating unit 62a, the digest transmitting unit 62b, and the obtaining request processor 62c.

The digest generating unit 62a extracts each header that uniquely specifies the message from the messages stored in the queue to generate a digest having the extracted headers. In particular, at a predetermined timing, the digest generating unit 62a extracts only headers that are included in a predetermined number of the messages stored in the message storing queue 51 to combine the extracted headers to generate a digest and outputs the digest to the digest transmitting unit 62b described below. For example, when the number of messages stored in the message storing queue 51 are equal to or more than ten, the digest generating unit 62a generates a digest of ten messages stored in the message storing queue 51 and outputs the digest to the digest transmitting unit 62b described below. The digest generating unit 62a may be set to generate a digest even when the number of messages stored in the message storing queue 51 is less than ten, if the number of messages stored therein is less than ten for a fixed period of time.

The digest transmitting unit 62b transmits the digests generated by the digest generating unit 62a to the receiving apparatuses specified by the address information stored in the destination management list storage unit 52. In particular, upon receiving a digest from the digest generating unit 62a, the digest transmitting unit 62b reads out the address information stored in the destination management list storage unit 52 and duplicates the digest as many as the number of addresses contained in the stored address information. Then, the digest transmitting unit 62b adds the read address information to the destination of each digest to output the digest to the external I/F controlling unit 40. For example, the digest transmitting unit 62b adds the address information “111.222.333.444” to the destination of the digest to output the digest to the external I/F controlling unit 40.

Upon receiving a message obtaining request specifying any of the headers contained in the digest from any of the receiving apparatuses, the obtaining request processor 62c reads out a message corresponding to the specified header to transmit the message to the receiving apparatus that transmitted the message obtaining request. In particular, upon receiving a header from the receiving apparatus via the external I/F controlling unit 40, the obtaining request processor 62c reads out a message including the received header from the messages stored in the message storing queue 51 and having a header that is subjected to generate a digest. Then the obtaining request processor 62c adds a source of the received header to the destination of the read message to output the message to the external I/F controlling unit 40. For example, upon receiving the header including the information that is the product name “computer” and the source of “111.222.333.444”, the obtaining request processor 62c reads the message having the header including information that is the product name “computer” from the message storing queue 51. The obtaining request processor 62c adds the destination “111.222.333.444” to the read message to output the header to the external I/F controlling unit 40.

The destination address management list generating unit 63 manages the address information of the receiving apparatuses that is expecting to receive a digest. In particular, upon receiving the address information transmitted from the receiving apparatus via the external I/F controlling unit 40, the destination address management list generating unit 63 stores the address information in the destination management list storage unit 52. For example, upon receiving new address information “111.222.333.XXX”, the destination address management list generating unit 63 stores and adds the new address information in the destination management list storage unit 52 as the destination of the digest.

<Structure of Receiving Apparatus>

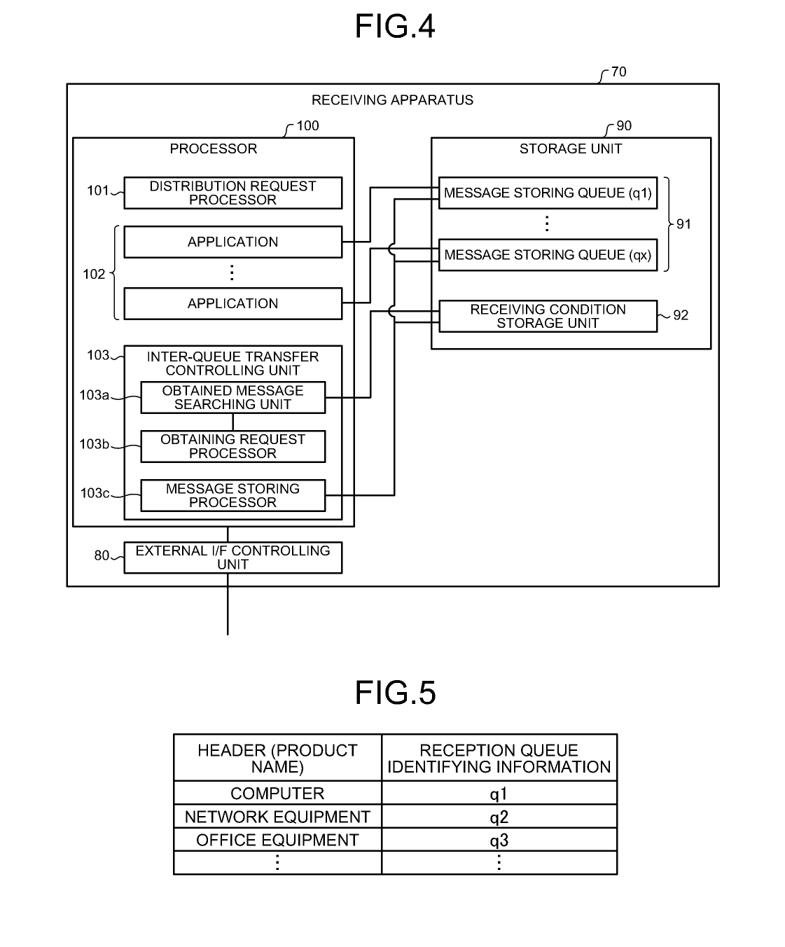

Referring to FIG. 4, components of the receiving apparatus 70 are explained. FIG. 4 is a block diagram of the receiving apparatus 70. As depicted in FIG. 4, the receiving apparatus 70 includes an external I/F controlling unit 80, a storage unit 90, and a processor 100.

The external I/F controlling unit 80 controls communication with the transmitting apparatus. In particular, upon receiving a header output from an obtaining request processor 103b described below, the external I/F controlling unit 80 outputs the header to a channel connected to the transmitting apparatus 30. Upon receiving a digest transmitted from the transmitting apparatus, the external I/F controlling unit 80 passes the digest to an obtained message searching unit 103a described below.

The storage unit 90 stores therein data used for various processes performed by the processor 100 and the like. As components closely related to the present invention, the storage unit 90 includes message storing queues 91 and a receiving condition storage unit 92. The receiving condition storage unit 92 corresponds to a phrase “receiving condition storage unit” set forth in claims.

The message storing queues 91 store therein a messages waiting to be processed by the application 102 described below. In particular, the message storing queues 91 receive and store therein the message from a message storing processor 103c described below. Identifying information that enables the message storing processor 103c to uniquely identify the message is added to the message storing queues 91. The message storing processor 103c stores the message in the message storing queues 91 in distributed manner based on the identifying information.

The receiving condition storage unit 92 stores therein receiving conditions that are information specifying the message to be received from the transmitting apparatus 30. In particular, as depicted in FIG. 5, the receiving condition storage unit 92 stores therein product names that are information included in headers and reception queue identifying information uniquely identifying the message storing queue in association with each other. For example, as depicted in FIG. 5, the receiving condition storage unit 92 stores therein a product name “computer” and reception queue identifying information “q1” in association with each other. FIG. 5 is an example of information stored in the receiving condition storage unit.

The processor 100 has an internal memory that stores therein computer programs and controlling data that specify various process procedures and executes various processes using the computer programs and controlling data. As components closely related to the present invention, the processor 100 includes a distribution request processor 101, the applications 102, and an inter-queue transfer controlling unit 103. Further, the inter-queue transfer controlling unit 103 includes the obtained message searching unit 103a, the obtaining request processor 103b, and the message storing processor 103c. The obtained message searching unit 103a corresponds to a phrase “searching unit” set forth in claims. Similarly, the obtaining request processor 103b corresponds to a phrase “message obtaining request transmitting unit” set forth in claims.

The distribution request processor 101 requests the transmitting apparatus 30 to distribute a digest. In particular, the distribution request processor 101 transmits, when it becomes able to communicate with the transmitting apparatus 30, address information of the receiving apparatus 70 in the network to the transmitting apparatus 30 via the external I/F controlling unit 80. For example, the distribution request processor 101 transits address information “111.222.333.444” to the transmitting apparatus 30.

The application 102 processes a message to be cooperatively processed with the application in the transmitting apparatus 30. In particular, when the message is stored in the corresponding message storing queue 91, the application 102 reads and further cooperatively processes the message.

The inter-queue transfer controlling unit 103 is a processor that controls the cooperative processing with the application 61 in the transmitting apparatus 30. The inter-queue transfer controlling unit 103 includes the obtained message searching unit 103a, the obtaining request processor 103b, and the message storing processor 103c

The obtained message searching unit 103a searches the digest received from the transmitting apparatus 30 for a header that satisfies the receiving conditions. In particular, upon receiving a digest from the transmitting apparatus 30 via the external I/F controlling unit 80, the obtained message searching unit 103a searches for a header including a product name stored in the receiving condition storage unit 92. When the obtained message searching unit 103a found a header including a product name in the digest, the obtained message searching unit 103a extracts the header from the digest and outputs to the obtaining request processor 103b described below. For example, upon receiving a digest in which ten headers such as “computer”, “television”, “audio equipment”, “camera”, “car navigation equipment”, “telephone”, are combined, the obtained message searching unit 103a extracts, as a result of searching, a header including the product name “computer” stored in the receiving condition storage unit 92 and outputs the header to the obtaining request processor 103b.

The obtaining request processor 103b transmits a message obtaining request containing the header found to satisfy the receiving conditions to the transmitting apparatus 30. In particular, upon receiving a header from the obtained message searching unit 103a, the obtaining request processor 103b adds address information of the receiving apparatus 70 as a source to the header. The obtaining request processor 103b transmits the header having a source added to the transmitting apparatus 30 via the external I/F controlling unit 80. For example, the obtaining request processor 103b adds address information “111.222.333.444” of the receiving apparatus 70 to a header including the product name “computer” to transmit the header to the transmitting apparatus 30.

The message storing processor 103c stores messages transmitted from the transmitting apparatus 30 in the message storing queues 91 in distributed manner. In particular, upon receiving a message transmitted from the transmitting apparatus 30 via the external I/F controlling unit 80, the message storing processor 103c stores the messages in the appropriate message storing queue 91 based on the reception queue identifying information corresponding the header of the message by referring the associations stored in the receiving condition storage unit 92. For example, upon receiving a message having the header including information that is the product name “computer”, the message storing processor 103c stores the message in the message storing queue 91 provided with the reception queue identifying information “q1” based on the reception queue identifying information “q1” corresponding to the product name “computer” (see FIG. 5).

<Process Performed by Transmitting Apparatus and Receiving Apparatus>

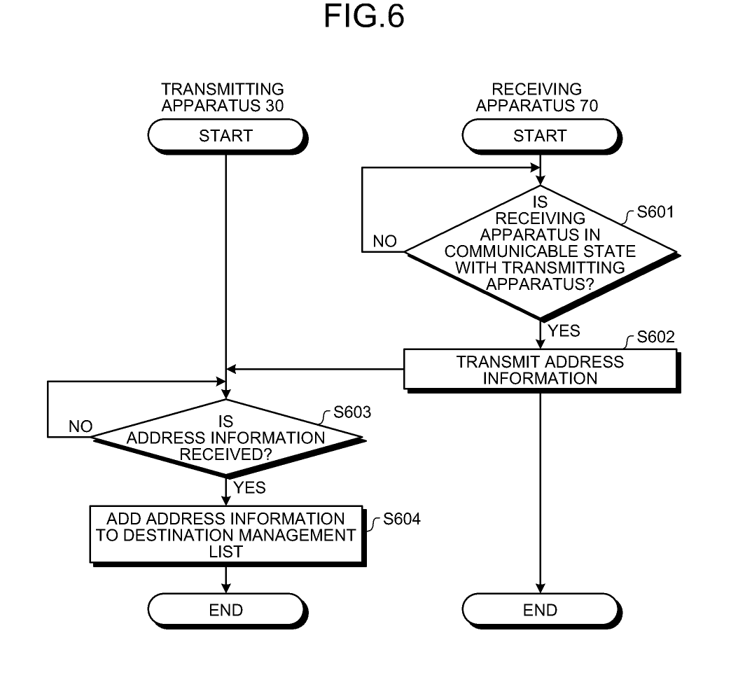

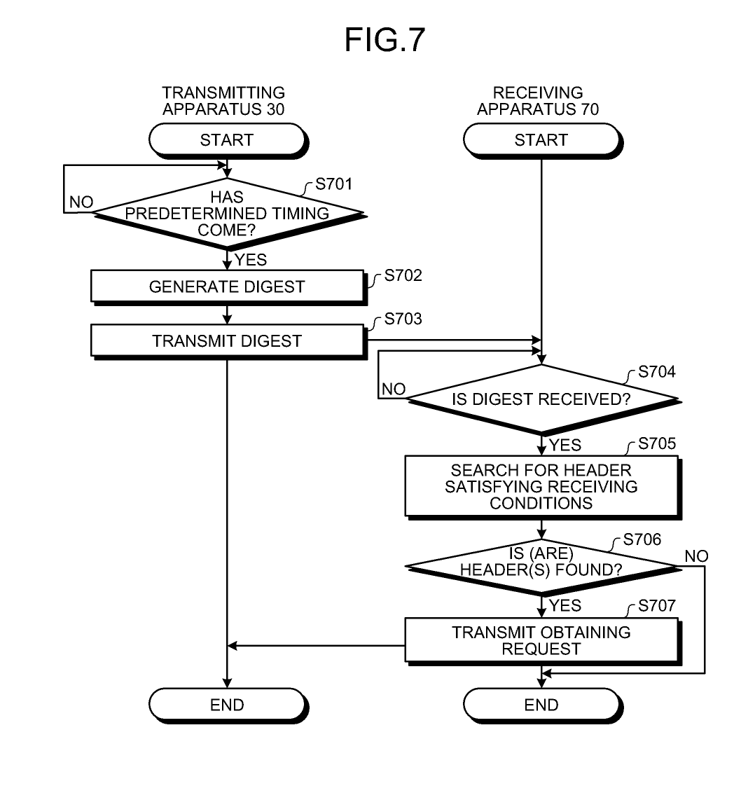

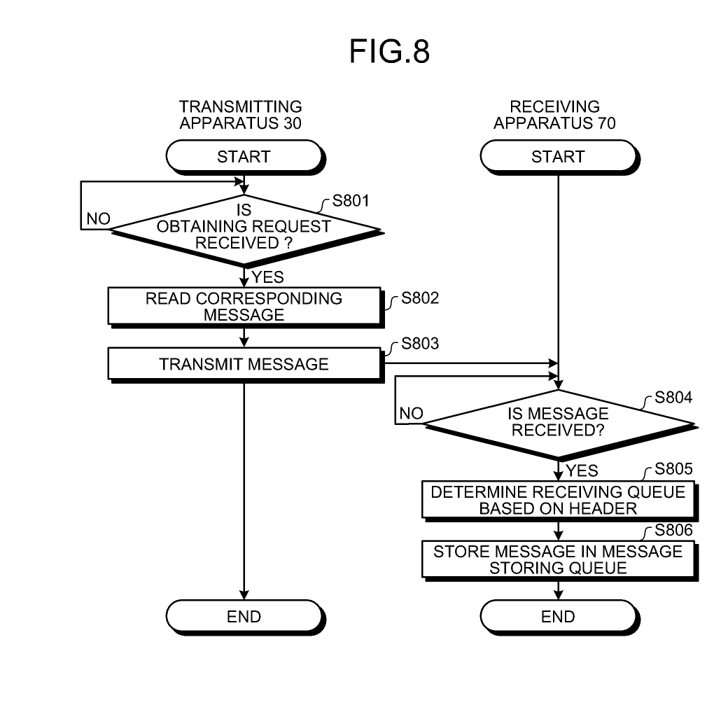

Referring to FIGS. 6, 7, and 8, the processing by the transmitting apparatus 30 and the receiving apparatus 70 is explained. FIG. 6 is a flowchart of a process flow of generating a destination management list according to the first embodiment. FIG. 7 is a flowchart of a process flow of obtaining a message according to the first embodiment. FIG. 8 is a flowchart of a process flow of receiving a message according to the first embodiment.

As depicted in FIG. 6, when the receiving apparatus 70 becomes in a communicable state with the transmitting apparatus 30 (YES at Step S601), the receiving apparatus 70 transmits the address information thereof to the transmitting apparatus 30 (Step S602). Subsequently, upon receiving the address information transmitted from the receiving apparatus 70 (YES at Step S603), the transmitting apparatus 30 adds the address information to the destination management list (Step S604).

As depicted in FIG. 7, when the transmitting apparatus 30 is at a predetermined timing (YES at Step S701), the transmitting apparatus 30 generates a digest from a message stored in the message storing queue 51 (Step S702) and transmits the digest based on address information stored in the destination management list storage unit 52 (Step S703). Subsequently, upon receiving the digest transmitted from the transmitting apparatus 30 (YES at Step S704), the receiving apparatus 70 searches the digest for a header containing a product name stored in the receiving condition storage unit 92 (Step S705). If the receiving apparatus 70 finds the header containing the product name in the digest (YES at Step S706), the receiving apparatus 70 extracts the header, adds the address information of the receiving apparatus 70 as a source to the header, and transmits the header to the transmitting apparatus 30 (Step S707).

AS depicted in FIG. 8, the transmitting apparatus 30 receives the message obtaining request by receiving the header transmitted from the receiving apparatus 70 (YES at Step S801). Then, the transmitting apparatus 30 reads out the message including the received headers from the message storing queue 51 (Step S802) and adds the source of the received header to the destination to transmit the header (Step S803). Subsequently, upon receiving the message transmitted from the transmitting apparatus 30 (YES at Step S804), the receiving apparatus 70 determines a message storing queue 91 that should store the message by referring to the associations stored in the receiving condition storage unit 92 (Step S805) and stores the message in the message storing queue 91 (Step S806).

<Effect of First Embodiment>

As described above, according to the first embodiment, the transmitting apparatus stores therein address information of the receiving apparatuses that is expecting to receive the digests. The transmitting apparatus extracts a header that uniquely specifies each of the messages stored in a queue to generate a digest having the extracted headers. The transmitting apparatus transmits the digest to a receiving apparatus specified by the address information. Upon receiving a message obtaining request specifying the header information included in the digest from any of the receiving apparatuses, the transmitting apparatus searches the queue for a message corresponding to the specified header information to transmit the message to the receiving apparatus that transmitted the message obtaining request. The receiving apparatus stores therein receiving conditions that are information used to specify a message to be received from a transmitting apparatus. The receiving apparatus searches the digest received from the transmitting apparatus for a header satisfies the receiving conditions to transmit the message obtaining request containing the header found as satisfying the receiving conditions to the transmitting apparatus. In this way, it is possible to flexibly construct a communication relationship among systems.

In particular, when the transmitting apparatus initiatively sets the communication definition, the following benefits are obtained. (1) Each time the receiving system is added or modified, the destination management list is updated with the address information transmitted from the receiving apparatus. Therefore, the transmitting system does not need to modify the definition, making tasks simple relating to the communication relationship construction. (2) The transmitting apparatus needs to include only one transmission queue. Even though the receiving system is added or modified, the transmitting apparatus is not required to increase the number of the transmission queues, making tasks simple relating to the communication. (3) The application in the transmitting apparatus needs to store the message in only one transmission queue. The application is not required to modify the logic used to store the message in synchronous with the addition or modification of the receiving system, making tasks simple relating to the communication. (4) The transmitting apparatus needs to include only one transmission queue. The transmitting apparatus is not required to increase a memory capacity in accordance with addition of the receiving system, making it possible to construct the communication relationship among systems at low costs. (5) The transmitting apparatus processes each generated digest independently from the reception queue, making it possible to maintain processing rate by controlling load on a CPU per message. (6) Any setting of the destination conditions are not required in the transmitting apparatus, making tasks simple relating to the communication.

When the transmitting apparatus initiatively sets the communication definition, the following benefits are obtained. (7) The transmitting apparatus needs to include only one transmission queue. Even though the receiving system is added or modified, the transmitting apparatus is not required to increase the number of the transmission queues, making tasks simple relating to the communication. (8) The application in the transmitting apparatus needs to store the message in only one transmission queue. Therefore, the application is not required to modify the logic used to store the message in synchronous in association with the addition or modification of the receiving system, making tasks simple relating to the communication. (9) The receiving apparatus processes based on a digest transmitted from the transmitting apparatus. Therefore, the receiving apparatus does not require continuous monitoring control such as by polling, making tasks simple relating to the communication.

### [b] Second Embodiment

While the first embodiment of the present invention has been explained, the present invention may be implemented in various embodiments other than the embodiment described above. As depicted below, the different embodiments are explained in sections (1) to (5).

(1) Message Content

In the first embodiment, while the message is explained as including the header and the message content, the present invention is not limited to this. The message body containing the message content may store information that is needed to obtain the message content (for example, address information indicating where the message content is located or the like). To explain this specifically, when the message content and the message body are stored in different locations, information (hereinafter, a “unique key”) that associates the message body with the message content is added. As following the process flow depicted in FIG. 8, upon receiving the header transmitted from the receiving apparatus 70 (YES at Step S801), the transmitting apparatus 30 reads out the message having the header received from the message storing queue 51 (Step S802). Then, the transmitting apparatus 30 reads out the message content from the storing location indicated by the address information contained in the message body in the message based on the unique key provided to the message body. After including the retrieved message content into the message body, the transmitting apparatus 30 proceeds to the process at “Step S803”.

(2) Message Components

In the first embodiment, while the message stored in the queue is explained as stored in the queue with the header being always associated with the message content, the present invention is not limited to this. The header may be stored in a different storage location from the message content. To explain this specifically, information (hereinafter, a “unique key”) that associates the message body with the message content is added. When the header is found that contains the product name in the digest, the receiving apparatus 70 transmits the unique key added to the header to the transmitting apparatus 30. Upon receiving the unique key transmitted from the receiving apparatus 70, the transmitting apparatus 30 reads out the header and the message content from each storage location based on the unique key to transmit the message to the receiving apparatus 70 with the header being associated with the message content. Instead of the unique key, the receiving apparatus 70 may transmit the header itself found as a result of searching to the transmitting apparatus 30.

(3) Reception Queue

In the first embodiment, while the transmitting apparatus 30 and the receiving apparatus 70 are explained as including the queues and cooperatively processing the message asynchronously, the present invention is not limited to this. The receiving apparatus 70 may continuously operate and cause the application to cooperatively process the message synchronously, whereby obviating the need for the receiving apparatus 70 to include the queue.

(4) System Components and Others

Each component of the apparatuses depicted in the drawings is conceptual in function, and is not necessarily physically configured as depicted. That is, the specific forms of distribution and integration of the components are not meant to be limited to those depicted in the drawings. All or part of the components may be functionally or physically distributed or integrated in arbitrary units according to various loads and the state of use. For example, the digest generating unit 62a may be integrated into the digest transmitting unit 62b. Further, all or arbitrary part of process functions performed in each component may be achieved by a Central Processing Unit (CPU) and a computer program analyzed and performed on the CPU, or may be achieved as hardware with a wired logic.

In addition, among the processes explained in the embodiments, all or part of the processes explained as being automatically performed may be manually performed, or all or part of the processes explained as being manually performed may be automatically performed through a known method. For example, in the embodiment, while the receiving apparatus is explained as automatically transmitting the address information when the receiving apparatus is in a state that can communicate with the transmitting apparatus, the receiving apparatus may transmit the address information triggered by an operator doing a predetermined operation. In addition, the process procedure, control procedure, specific names (for example, the product name “computer” or the like), and information including various data and parameters explained in the specification and depicted in the drawings may be arbitrarily changed unless otherwise specified.

(5) Message Transfer Programs

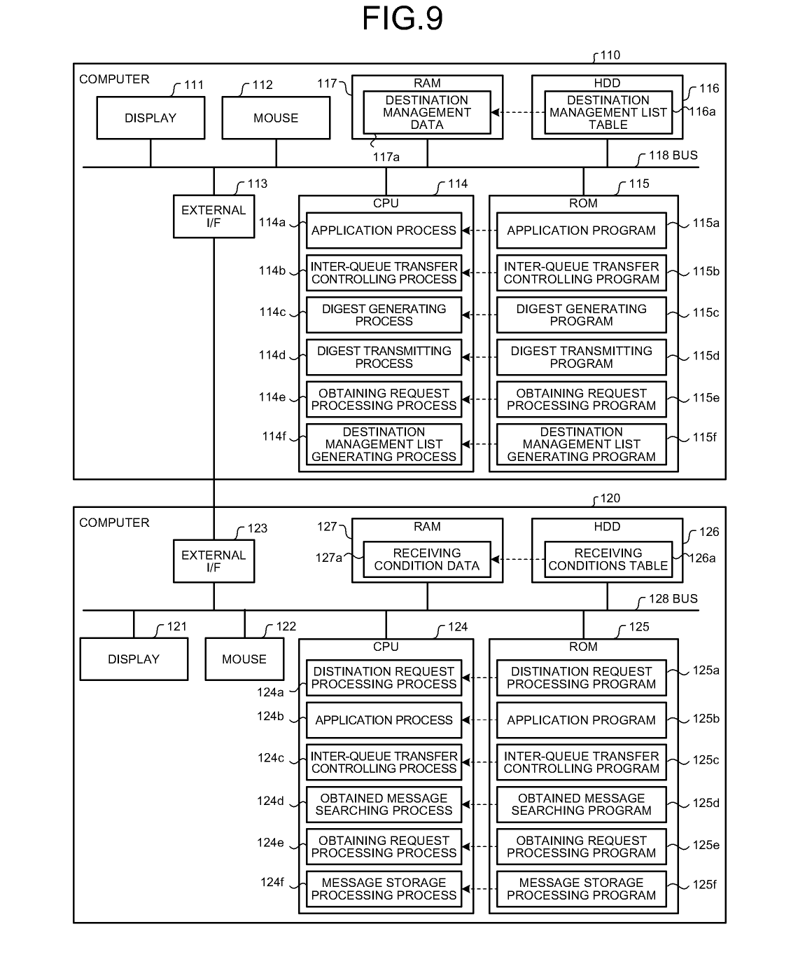

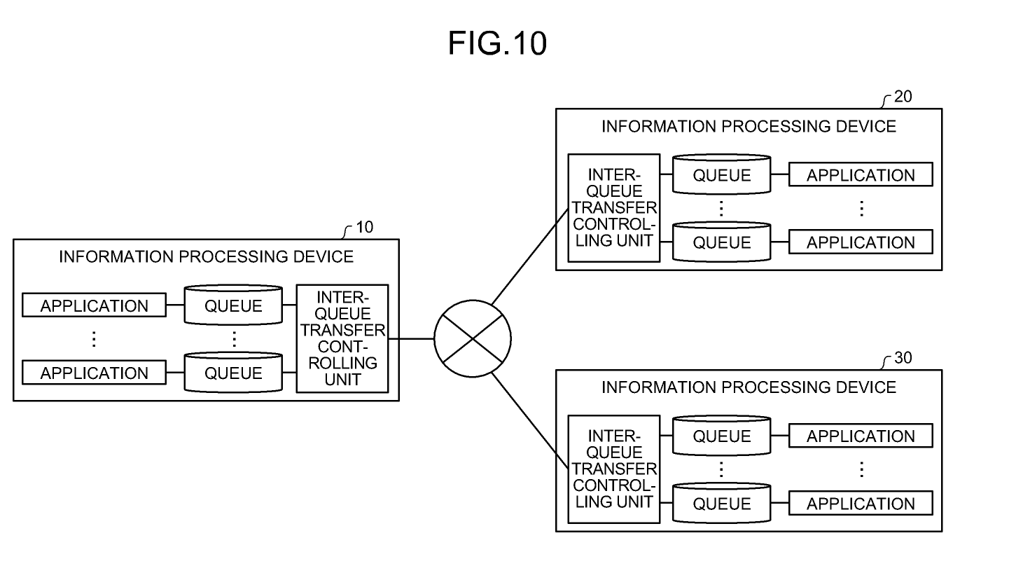

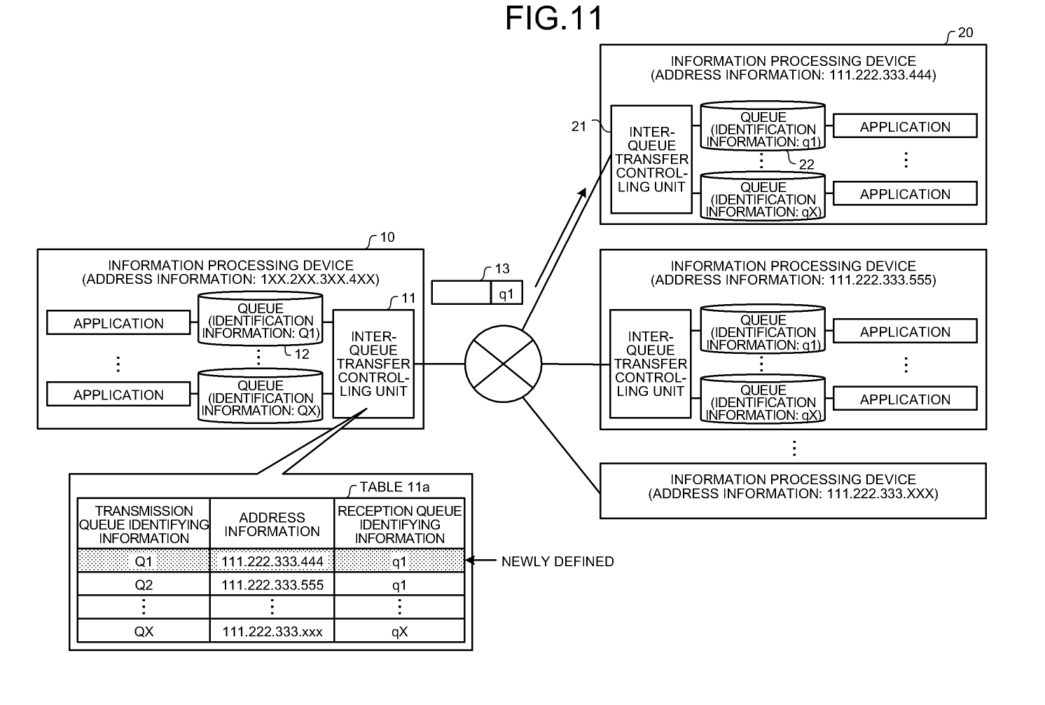

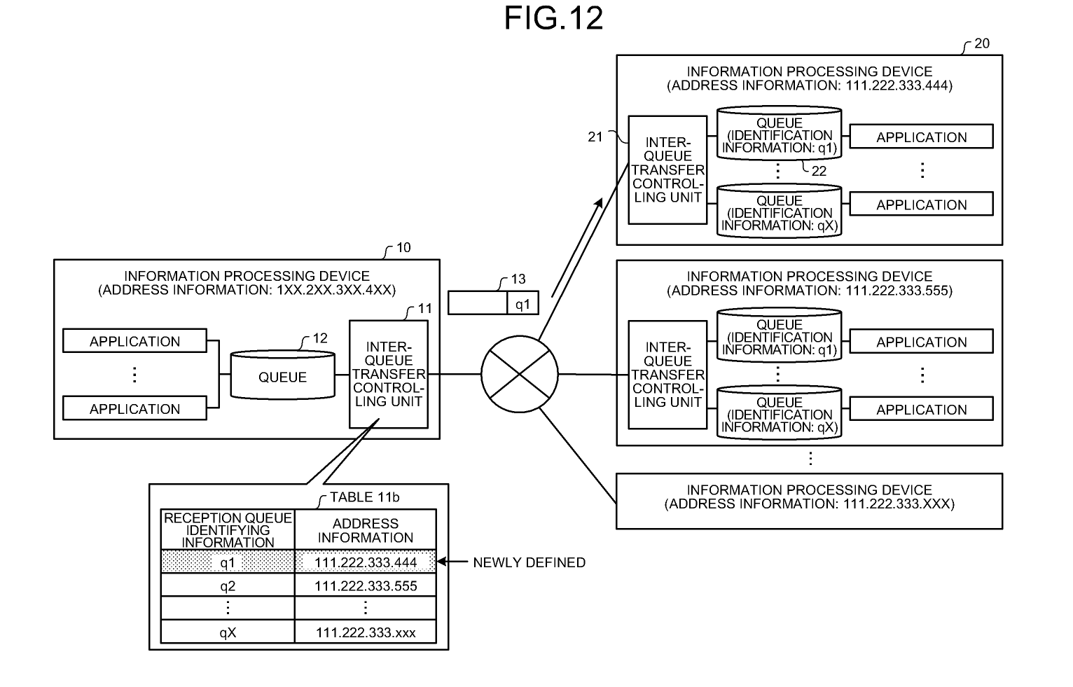

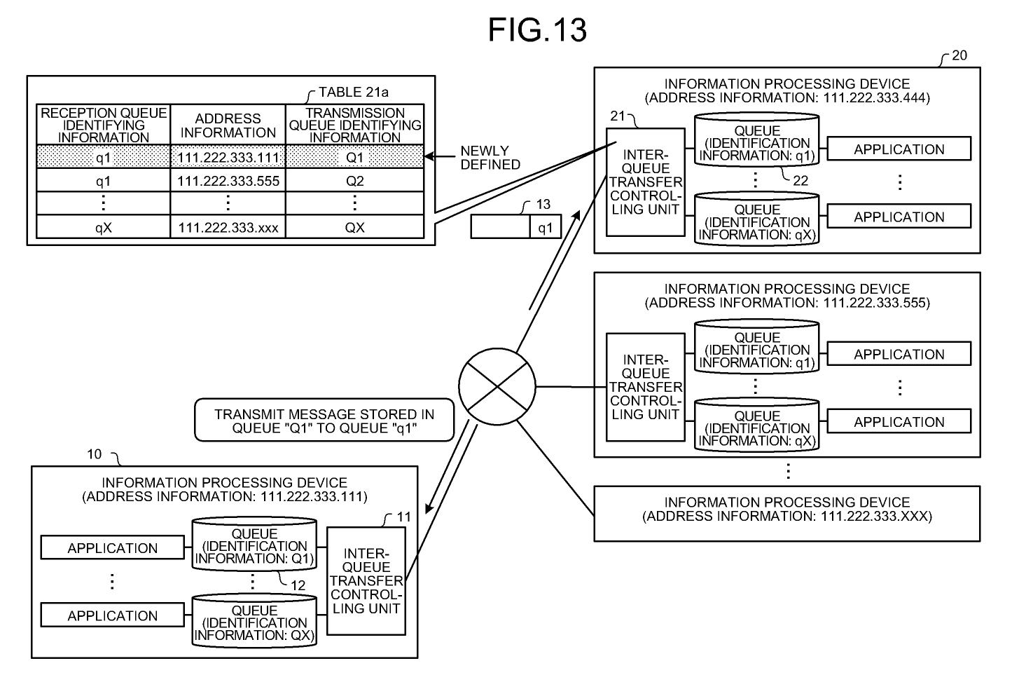

While the first embodiment is explained as a case for realizing various processes by hardware logics, the present invention is not limited to this. The present invention may be achieved by causing a computer to execute computer programs prepared in advance. Referring to FIG. 9, an exemplary computer that executes message transfer programs having the same functionalities as those of the message transfer system depicted in the first embodiment is explained. FIG. 9 is a schematic of the computer that executes the message transfer programs.

As depicted in FIG. 9, a computer 110 functioning as the transmitting apparatus 30 includes a display 111, a mouse 112, an external I/F 113, a CPU 114, a read only memory (ROM) 115, a hard disk drive (HDD) 116 and a random access memory (RAM) 117, which are connected via a bus 118 or the like.

The ROM 115 stores therein in advance message transfer programs having similar functionalities as those of the transmitting apparatus 30 depicted in the first embodiment. That is, as depicted in FIG. 9, the ROM 115 stores therein in advance an application program 115a, an inter-queue transfer controlling program 115b, a digest generating program 115c, a digest transmitting program 115d, an obtaining request processing program 115e, and a destination management list generating program 115f. As with the various components of the transmitting apparatus 30 depicted in FIG. 2, these computer programs 115a to 115f may be appropriately integrated or distributed.

The CPU 114 reads out and executes these computer programs 115a to 115f from the ROM 115. As a result, as depicted in FIG. 9, the computer programs 115a to 115f function as an application process 114a, an inter-queue transfer controlling process 114b, a digest generating process 114c, a digest transmitting process 114d, an obtaining request processing process 114e, and a destination management list generating process 114f. The processes 114a to 114f correspond to the application 61, the inter-queue transfer controlling unit 62, the digest generating unit 62a, the digest transmitting unit 62b, the obtaining request processor 62c, and the destination address management list generating unit 63 as depicted in FIG. 2, respectively.

As depicted in FIG. 9, the HDD 116 is provide with a destination management list table 116a. The destination management list table 116a corresponds to the destination management list storage unit 52 depicted in FIG. 2. The CPU 114 reads out destination management data 117a from the destination management list table 116a to store the destination management data 117a in the RAM 117 and performs processes relating to message transferring based on the destination management data 117a stored in the RAM 117.

A computer 120 functioning as the receiving apparatus 70 includes a display 121, a mouse 122, an external I/F 123, a CPU 124, a ROM 125, an HDD 126, and a RAM 127, which are connected via a bus 128.

The ROM 125 stores therein in advance message transfer programs having similar functionalities as those of the receiving apparatus 70 depicted in the first embodiment. That is, as depicted in FIG. 9, the ROM 125 stores therein in advance a destination request processing program 125a, an application program 125b, an inter-queue transfer controlling program 125c, an obtained message searching program 125d, an obtaining request processing program 125e, and a message storage processing program 125f.

The CPU 124 reads out and executes these computer programs 125a to 125f from the ROM 125. As a result, as depicted in FIG. 9, the computer programs 125a to 125f function as a destination request processing process 124a, an application process 124b, an inter-queue transfer controlling process 124c, an obtained message searching process 124d, an obtaining request processing process 124e, and a message storage processing process 124f. The processes 124a to 124f correspond to the distribution request processor 101, the application 102, the inter-queue transfer controlling unit 103, the obtained message searching unit 103a, the obtaining request processor 103b, and the message storing processor 103c as depicted in FIG. 4, respectively.

As depicted in FIG. 9, the HDD 126 is provide with a receiving conditions table 126a. The receiving conditions table 126a corresponds to the receiving condition storage unit 92 depicted in FIG. 4. The CPU 124 reads out receiving condition data 127a from the receiving conditions table 126a and stores in the RAM 127, and performs processes relating to message transferring based on the receiving condition data 127a stored in the RAM 127.

The computer programs 115a to 115f and 125a to 125f are not necessarily stored in the ROMs 115 and 125 from the beginning. The computer programs 115a to 115f and 125a to 125f can be stored in, for example, a “portable physical medium”, such as a flexible disk (FD), a CD-ROM, a magneto-optical (MO) disk, a digital versatile disk (DVD), or an integrated circuit (IC) card that can be inserted to the computers 110 and 120, in “a fixed physical medium” such as a HDD that is located internal or external to the computers 110 and 120, or in “another computer (or server)” that can be connected to the computers 110 and 120 via a public line, the Internet, a local area network (LAN), a wide area network (WAN), or the like, whereby the computers 110 and 120 read the computer programs from such a medium and execute them.

According to the present invention, it is possible to flexibly construct the communication relationships among the systems.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions that, when executed by a computer functioning as a transmitting apparatus that transfers a message stored in a queue to a plurality of receiving apparatuses communicatively connected to each other via a network, causes the computer to perform:
extracting header information that uniquely specifies each message from a plurality of such messages stored in the queue to generate a digest by collecting the extracted header information;
transmitting the digest generated at the extracting to the receiving apparatuses; and
reading out, upon receiving a message obtaining request specifying any header information contained in the digest from any of the receiving apparatuses, a message corresponding to the specified header information from the queue to transmit the message to the receiving apparatus that transmitted the message obtaining request.

2. A message transfer method of transferring a message stored in a queue to a plurality of receiving apparatus communicatively connected to each other via a network, the message transfer method comprising:
extracting header information that uniquely specifies each message from a plurality of such messages stored in the queue to generate a digest by collecting the extracted header information;
transmitting the digest generated at the extracting to the receiving apparatuses; and
reading out, upon receiving a message obtaining request specifying any header information contained in the digest from any of the receiving apparatuses, a message corresponding to the specified header information from the queue to transmit the message to the receiving apparatus that transmitted the message obtaining request.

3. A message transfer system including a plurality of receiving apparatuses that receive messages and a transmitting apparatus that transfers the messages stored in a queue to the receiving apparatuses, the receiving apparatuses and the transmitting apparatus being communicatively connected via a network,
the transmitting apparatus comprising:
a digest generating unit that extracts header information that uniquely specifies each message from the messages stored in the queue to generate a digest by collecting the extracted header information;
an address information storage unit that stores therein address information of any of the receiving apparatuses that are expecting to receive the digest generated by the digest generating unit;
a digest transmitting unit that transmits the digest generated by the digest generating unit to the receiving apparatuses specified in the address information stored in the address information storage unit; and
a message transmitting unit that, upon receiving a message obtaining request specifying any header information contained in the digest from any of the receiving apparatuses, reads out a message corresponding to the specified header information from the queue to transmit the message to the receiving apparatus that transmitted the message obtaining request, and
the receiving apparatus comprising:
a receiving condition storage unit that stores therein receiving conditions that specify a message to be received from the transmitting apparatus;
a searching unit that searches the digest received from the transmitting apparatus for header information that satisfies the receiving condition stored in the receiving condition storage unit; and
a message obtaining request transmitting unit that transmits a message obtaining request that contains the header information searched for by the searching unit that satisfies the receiving conditions to the transmitting apparatus.
